(19) United States
(12) Patent Application Publication
(10) Pub. No.: US 2010/0174689 A1
(43) Pub. Date: Jul. 8, 2010

(54) DOCUMENT MANAGEMENT APPARATUS, DOCUMENT MANAGEMENT SYSTEM, DOCUMENT MANAGEMENT METHOD, AND COMPUTER PROGRAM

(75) Inventor: Ryo Maeda, Fujisawa-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/642,959

(22) Filed: Dec. 21, 2009

(30) Foreign Application Priority Data
Jan. 7, 2009 (JP) 2009-001636

(51) Int. Cl. G06F 17/00

(52) U.S. Cl. 707/694; 707/E17.005

(57) ABSTRACT

A folder or a file managed in a document management apparatus includes a document with a high confidentiality or personal information, on which only a specific user has an access right. These are frequently stored in a personal folder, and there is a problem that the file or the like within the personal folder cannot be accessed at all when a user account has been deleted because of user's transfer or the like. When a user account has been deleted, the file, on which a user, the user account of whom has been deleted, has the access right, is encrypted and stored in a common area. The user is informed of a guest account for accessing the common area, a password for decrypting the encrypted file and the like. The former user can obtain the file by logging-in to the document management apparatus using the guest account.

### BACKGROUND OF THE INVENTION

1. Field of the Invention

The present invention relates to a document management apparatus, a document management system, a document management method, and a computer program, each of which has a file management function, a user management function, and a data transmission function via a network.

2. Description of the Related Art

Recently, a storage capacity capable of storing various kinds of data is increasing and a document management apparatus has been used generally and widely. That is, there have been increasing opportunities to centrally manage internal documents in a company or the like by the document management apparatus. In the case of using such a document management apparatus, the same document management apparatus is frequently used commonly among a plurality of users within the same department of a company or the like. Then, access control is carried out for a file or a folder which is managed by the document management apparatus and relates to the job and work of each user. In the access control, it is possible to allow only a specific user in a limited range to use a certain kind of file or to disclose a file only within a certain group, by assigning an access right to each user. Generally the access right is set by a creator of the file or a system manager of the document management apparatus.

By the above access control, it is possible to create a folder which can be referred to only by a user himself/herself linked with a user account identifying each user. Such a folder is called a personal folder, for example, and frequently stores a file with a high confidentiality or a file with a high importance and further stores information regarding the user himself/herself and the like, because the other users cannot refer to the folder.

In such a situation, when a certain user has an opportunity of movement, transfer, resignation or the like, it is usual to extinguish a use right of the document management apparatus which the user has utilized so far. That is, a user account registration is deleted for the user who has the opportunity of movement or the like. In this case, it becomes very important how to treat a file or a folder which has been accessible only to the user himself/herself. For example, when the file or the folder accessible only to the user himself/herself remains as it is, the file or the folder which nobody can access remains and consumes the storage capacity in vain.

Regarding this point, in a conventional document management apparatus, there is proposed a method of deleting all the files or the like which has been managed by the certain user of a user account when the user account is deleted, for example (refer to Japanese Patent Laid-Open No. H3-100838 (1991)). By this method, all the documents or the like managed by the user are completely deleted, and thereby the document or the like is not referred to by the other users and a storage capacity of a size occupied by the deleted file or the like can be utilized for storing another file or the like.

However, there is a possibility that the file becomes necessary after the deletion of the file or the like or the user account is deleted erroneously. Accordingly, it is not desirable to delete a personal file or the like corresponding to the deleted user account immediately after the deletion of the user account.

There is proposed another method that the access right of the file managed by the user of a user account is transferred to a system manager or another user when the user account is deleted (refer to Japanese Patent Laid-Open No. H8-115245 (1996)). However, it is desirable not to allow completely another user to refer to a document with a particularly high confidentiality such as personal information, and this method cannot satisfy such a desire. Further, even when the access right is transferred to the system manager, it is considerably complicated to obtain a file through the system manager, depending on operation as in the case that the access of a desired file requires a request to the system manager at each time.

As described above, it is desirable not to allow a person except a user himself/herself to refer to a document file or the like with a particularly high confidentiality such as personal information. Further, it is desirable to allow a personal file or the like to remain at least for a certain period and to keep a state in which the user can access continuously even after the user account has been deleted.

That is, if only a user himself/herself with a user account deleted can access a document or the like which has been under his or her management for a certain period after the deletion of the user account although the other users cannot access the document or the like, the convenience of the document management apparatus will be further improved. However, there has not been proposed a method to satisfy such a desire.

### SUMMARY OF THE INVENTION

The present invention is provided with the following configuration for solving the above problem.

A document management apparatus of the present invention includes: a user management component configured to manage a user account and notification destination information of a user; a document management component configured to manage a folder and/or a file and to perform access control according to an access right set for the folder and/or the file; an encryption component configured to encrypt specific folder and/or file when the user management component has deleted the user account; and a notification component configured to notify a user, the user account of whom has been deleted, of information for the user to access the encrypted folder and/or file according to the notification destination information.

According to the present invention, when the user account for accessing the document management apparatus has been deleted, the file or the folder, on which the user to be deleted has the access right, is subjected to encryption processing and stored in a common folder. Then, the user to be deleted is notified of information for accessing the encrypted file.

Thereby, even after the user account has been deleted, the user of the deleted user account (or a person permitted by the user) can access the file or the like which was under the user's management in a certain condition.

In addition, for the personal file or the like remaining in a storage area after the deletion of the user account, confidentiality can be kept by the encryption processing.

Further, by deleting the remaining file or the like after a certain period has elapsed, it is possible to prevent the storage capacity being excessively consumed.

In addition, since it becomes unnecessary to request a system manager to obtain a desired file at each time, it is possible to reduce a burden such as labor or time which the user or the system manager has required so far for the request.

Further features of the present invention will become apparent from the following description of exemplary embodiments (with reference to the attached drawings).

### BRIEF DESCRIPTION OF THE DRAWINGS

FIG. 1 is a functional block diagram of a document management apparatus according to Embodiment 1 of the present invention;

FIG. 2 is a diagram showing an example of a user management table;

FIG. 3 is a diagram showing a tree structure managing a folder or a file;

FIG. 4 is a diagram showing an example of an access right table;

FIG. 5 is a flowchart showing the control processing of the present invention according to Embodiment 1;

FIG. 6 is a functional block diagram of a document management system according to Embodiment 2 of the present invention; and

FIG. 7 is a flowchart showing the control processing of the present invention according to Embodiment 2.

### DESCRIPTION OF THE EMBODIMENTS

### Embodiment 1

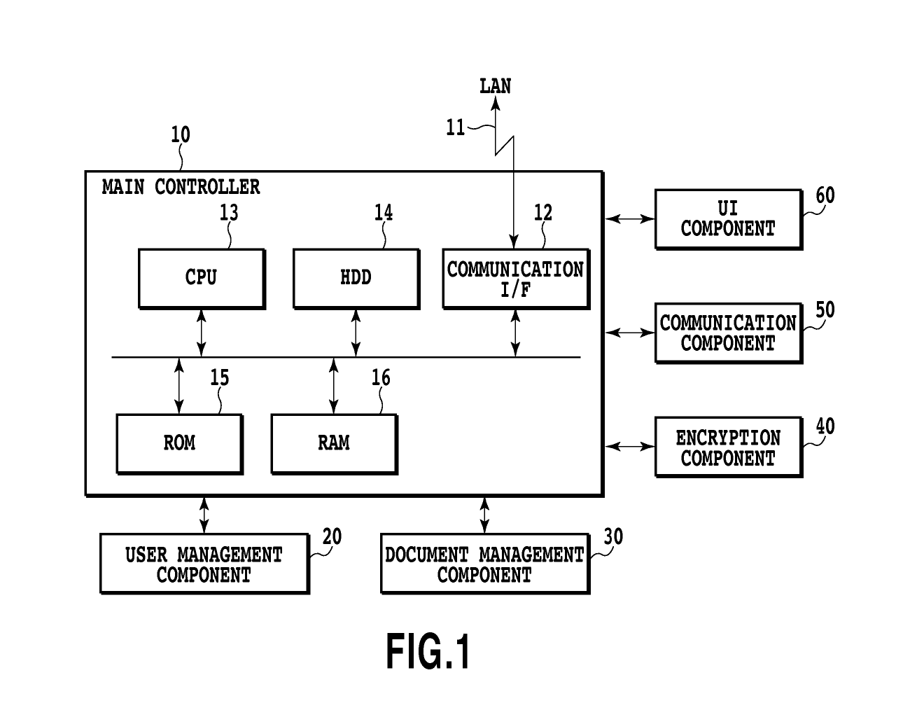

An example of a document management apparatus according to the present invention will be described briefly by the use of a function block diagram shown in FIG. 1. The document management apparatus includes a main control component 10, a user management component 20, a file management component 30, an encryption component 40, a communication component 50, and a user interface component 60. The main control component 10 is configured mainly with a LAN 11, a communication interface 12, a CPU 13, an HDD 19, a ROM 15, and a RAM 16.

The LAN 11 is a network for carrying out data exchange with an external apparatus (not shown in the drawing). The various kinds of data exchange with the external apparatus via the LAN 11 are carried out through the communication interface 12. Further, the communication interface 12 supports various kinds of protocol such as SMB, WebDAV, FTP, and E-Mail.

The CPU 13 controls the operation of the entire document management apparatus and executes a program stored in the ROM 15 or a program loaded from the HDD 14 into the RAM 16.

The HDD 14 is a system work memory for the operation of the CPU 13 and stores various kinds of data and the like.

The ROM 15 is a boot ROM and stores a system boot program. The RAM 16 functions as a main memory, a work area, and the like for the operation of the CPU 13.

The main control component 10 controls respective components such as the user management component 20, the file management component 30, the encryption component 40, the communication component 50, and the user interface component 60.

The user management component 20 performs management of a user utilizing document management apparatus, such as the registration, issue, update, and deletion of a user account. The user management component 20 has a user management table 100 for storing user information (the user management table 100 will be described hereinafter). Typically, the user management table is stored on the HDD 14.

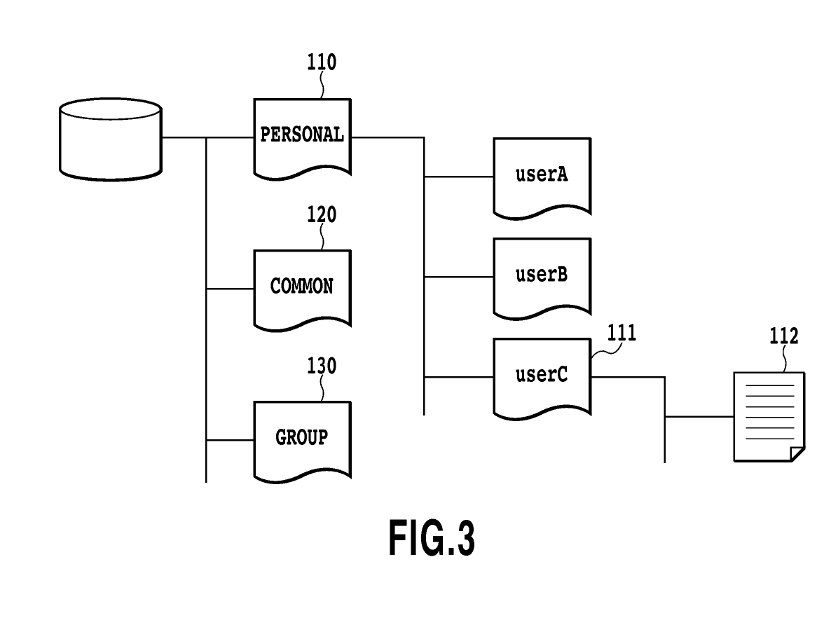

The document management component 30 manages a folder or a file created and edited by each user. The document management component 30 manages the folder or the file in a tree structure as shown in FIG. 3, for example, and performs access control according to an access right set for each folder or file. Note that the various kinds of folder or file are stored on the HDD 14.

The encryption component 40 performs encryption of a folder or a file.

The communication component 50 performs communication with an external device (e.g., personal computer (PC), MFP, etc. in addition to a file server to be described hereinafter) connected thereto via the LAN 11. Further, the communication component 50 also performs control of switching a protocol of the communication interface 12 depending on communication contents. Note that the LAN 11 is an example of a network and the network may be the Internet, a WAN, or a combination of these networks.

The user interface component 60 is configured with a display provided with a touch key and the like, and performs the reception of a user instruction and the display of various kinds of data.

As described above, the outline of the document management apparatus according to the present invention has been described briefly. Next, the user management component and the document management component will be described in more detail.

### (User Management Component)

User management processing in the user management component 20 will be described.

First, the main control component 10 reads a program stored in the ROM 15 and causes the CPU 13 to operate. The CPU 13 reads the user management table 100 stored on the HDD 14 through the user management component 20 and stores the table temporarily in the RAM 16. At the same time, the CPU 13 updates the contents of the user management table 100 stored temporarily in the RAM 16 according to an instruction of a system manager to be described hereinafter such as the registration of a new user and update or deletion according to the change of user information. Note that the above instruction is carried out through the user interface component 60. After the update processing, the CPU 13 updates the contents of the user management table 100 stored on the HDD 14 according to the updated contents of the user management table 100 in the RAM 16. When a new user has been registered in the user management table, a new user account is issued.

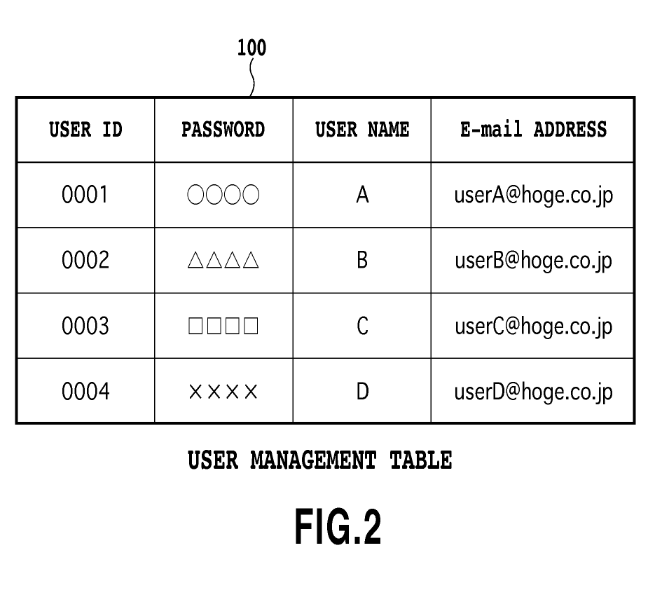

FIG. 2 shows an example of the user management table 100. As shown in FIG. 2, the user management table 100 is configured with user information organized for each user such as a user ID, a password, a user name and an E-mail address. In the present specification, among these sets of user information, the information (e.g., user ID and password) which identifies a user and is used for confirming whether or not the user has a right for utilizing the document management apparatus (login authentication to be described hereinafter) is called a user account. Note that the contents of the user account are not limited to the user ID and the password, and may include other information added to these sets of information or adversely may include only the user ID. That is, any information which is used for confirming whether a right of utilizing the document management apparatus exists or not can be the user account. The information indicating these user attributes which are managed by the user management table 100 are not limited to the user ID, the password, the user name and the E-mail address and may further include information such as a registration date, for example. In the present embodiment, the user management table 100 is retained on the HDD 19 within the document management apparatus to be referred to, but the user management table 100, which is managed by another apparatus and can be referred to through the LAN 11, also can be utilized.

The user management component 20 also performs the login authentication. The login authentication is a procedure confirming whether or not a user has a use right when the user is actually going to use the document management apparatus. For example, the login authentication causes the user, who is going to use the document management apparatus from now, to input the user ID and the password through the user interface component 60 and allows the user to use the document management apparatus only when the user passes a predetermined authentication. When the user passes the login authentication without a problem, the user can use the document management apparatus, but the user is not always allowed to access the file or the like completely freely. The user has an access limit to the file or the like according to the contents of the access right provided to the user (details of the access control will be described hereinafter).

Note that a known method can be applied to the login authentication. An example of the known login authentication includes, for example, authentication requesting only the user ID and the password, authentication using an IC card, authentication utilizing an authentication server outside the apparatus, authentication allowing the login authentication to pass without issuing an authentication request, etc.

In addition to the above, the user management component performs processing necessary for the management of a user who utilizes the document management apparatus such as the issue of a guest account to be described hereinafter.

### (Document Management Component)

Next, the management processing of a folder or a file in the document management component 30 will be described.

FIG. 3 is a conceptual diagram showing a state in which a folder or a file is managed by a so-called tree structure. The document management component 30 manages the folder and the file to be managed using the tree structure as shown in FIG. 3, for example, as same as a typical file server. Here, a folder 111 is a folder assigned to each user and is a personal folder which stores an important file with a high confidentiality or personal information. In the example of FIG. 3, the personal folders 111 are assigned to users A, B and C, respectively. Then, FIG. 3 shows a state in which a confidential file 112 created by the user C belongs to the personal folder 111 of the user C. A folder 110 is a higher level personal folder, a folder 120 is a common folder, and a folder 130 is a group folder. The higher level personal folder 110 is a folder including all the personal folders 111 assigned to respective users. The common folder 120 is a folder all the users can access who can login to the document management apparatus, and is a folder usually including a folder or a file used in common or the like. The group folder 130 is a folder used in common by users in a certain range such as within the same department, and utilized for managing a document which requires confidentiality to some extent not to be disclosed to another department. Incidentally, the folder is sometimes called a directory.

The main control component 10 reads a program stored in the ROM 15 and causes the CPU 13 to operate. The CPU 13 manages the folder or the file existing on the HDD 14 by the above tree structure through the document management component 30 according to a user instruction such as the creation, transfer, copy, edition, deletion, etc. of the file or the folder. Note that the above user instruction is carried out through the user interface component 60.

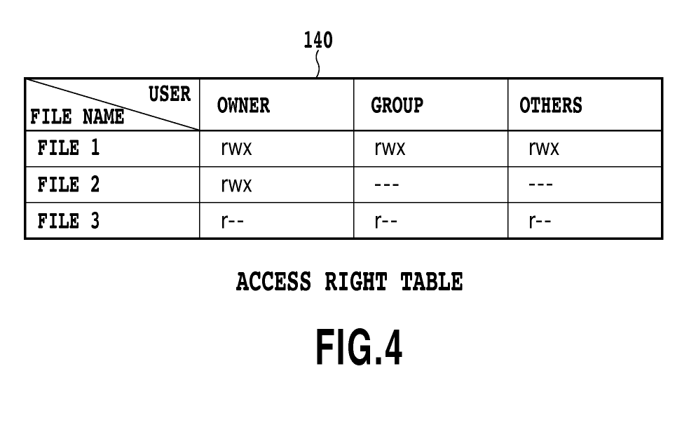

Further, the document management component 30 also performs the access control of the user for the folder or the file according to the contents of a preliminarily set access right. Here, the access right is managed by an access right table 140 as shown in FIG. 4, for example. In the access right table 140 of FIG. 4, the access right includes three kinds of right, a reading right (r) capable of browsing a file, a writing right (w) capable of carrying out edition such as a new writing in addition to the file browsing, and a execution right (x) capable of executing a file. Note that the access right is not limited to the above three kinds and can include any optional contents.

FIG. 4 shows a state in which users are divided into three divisions, an owner, a group, and the others and the access rights having the contents different from one another are set for the respective files. Here, the owner means a user himself/herself who creates the file, the group means users in a certain range which is set up optionally, and the others means users who are not the owner or the group. In the example shown in FIG. 4, the access right of File 1 is owned by the users in all the divisions of the owner, the group and the others for all the three kinds of reading, writing and execution. Meanwhile, the access right of File 2 is owned only by the owner for all the three kinds of reading, writing, and execution, and the group and the others are not provided with even the reading right. Further, for File 3, only the reading right is provided to the users in all the divisions of the owner, the group, and the others. Accordingly, when the File 2 is stored in the common folder, for example, users except the owner do not have even the reading right and the users except the owner cannot browse the contents of File 2. However, if the file is stored in the common folder, the existence itself of the file is known by the other users, and therefore a file such as File 2 is usually managed in the personal folder.

Note that the object of the access right table example in FIG. 4 is only the file, but a similar access right table can exist for the folder. Usually the access right is set by the user himself/herself who creates the object file or folder, and the change of the set contents can be carried out only by this user. That is, the personal folder can be easily created if the user himself/herself who is the file owner, for example, changes the access right setting. Further, it is also possible to create the personal folder for each user together with the generation of a user account in the registration of a new user.

When too complicated access control is not required, it is possible not to use the group folder at all, for example. In this case, only the common folder may be used or only the common folder and the personal folder may be used. Further, when the common folder is used, the password authentication may be carried out for each folder at each access, for example.

Further, a super user called the system manager who has all the rights for the management of the folder or the file may be set up. The system manager is a person who has a right necessary for managing the document management apparatus, that is, all the access rights of reading, writing, and execution for all the folders, all the directories, and all the files. Note that such a system manager may be set up optionally.

Next, there will be described a point of the present invention, that is, a method for a user whose user account was deleted, to access a file which was managed by the user himself/herself, after the deletion of the user account.

(Method for Accessing a File after the Deletion of a User Account)

There will be described a method for accessing a file which was managed by a user under a certain condition even after the deletion of a corresponding user account in the document management apparatus as described above.

When a certain user is moved to another department, is transferred to a branch office, or resigns a company, the user account of the user on the document management apparatus is usually deleted by the system manager or the like at the timing of the movement or the like. Then, if any measure is not provided for this situation, the user, to whom the deleted user account was assigned, cannot pass the above login authentication after that and cannot utilize the document management apparatus at all. The present invention employs the following method so as to realize access to a file or the like on which only the user himself/herself has the access right, for example, even after the deletion of the user account.

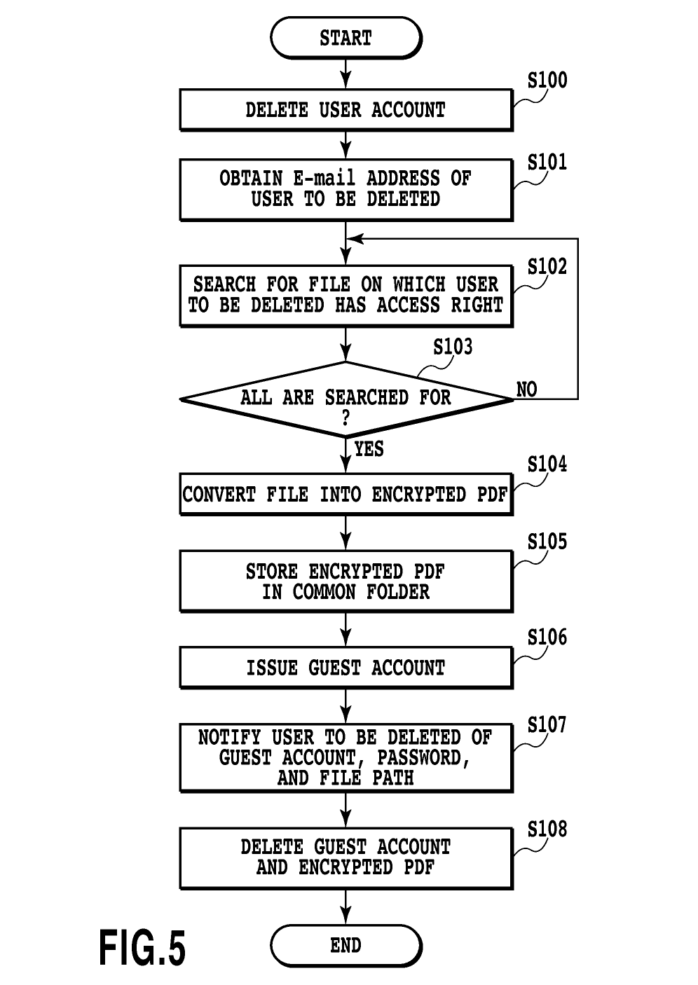

FIG. 5 is a diagram representing processing flow according to the present embodiment.

First, in Step 100, a user account is deleted for a specific user who anymore needs not be provided with a general use right for the document management apparatus because of the movement or the like. Specifically, the user management component 20 deletes user account information (user ID and password in the present embodiment) of the user to be deleted from the user management table 100.

When the user account has been deleted, the user management component 20 refers to the user management table 100, obtains an E-mail address of the user to be deleted as notification destination information, and stores the information into the RAM 16 (S101). After the obtaining of the notification destination information, the user name and also the E-mail address become unnecessary, and the user management component 20 extinguishes the whole information regarding the user to be deleted from the user management table 100. Note that a part of the information such as the user name may remain for a movement to be repeated or the like.

Next, in Step 102, the document management component searches for a file or a folder, the access right of which is owned by the user to be deleted, by referring to the access right table 190 (note that, although explanation below will be done only for a file for simplification, explanation is the same for a folder). Then, the document management component repeats this search processing until all the files, the access rights of which are owned by the user to be deleted, are found (S103).

When all the files have been found, the process goes to Step 104. In Step 104, the encryption component 40 carries out conversion processing into an encrypted PDF for the found file. Note that, details of a conversion processing method for the encrypted PDF will be omitted from description because the method is not a point of the present invention.

After the encryption processing has been completed in Step 104, the document management component 30 stores the converted encrypted PDF into a common folder which is a common area all the users can access (S105).

Subsequently, the user management component 20 issues a guest account for the user whose user account has been deleted (Step 106). Here, the guest account is a user account prepared for a user utilizing the document management apparatus temporarily. Usually the guest account is preliminarily prepared in a certain number for imparting a right of utilizing the document management apparatus temporarily to a person who visits for a business trip, a short term movement or the like, or is issued temporarily as needed.

Next, the communication component 50 notifies the user to be deleted of information for accessing the above encrypted file by an E-mail (S107). That is, the communication component 50 transmits the guest account issued in Step 106, a password decrypting the code of the encrypted PDF, and a file path indicating a location storing the common folder to a corresponding address using the E-mail address which is the notification destination information obtained in Step 101. The user receives the notification at any terminal such as a user's own PC in which the user can obtain and browse the E-mail. The user, having received the notification, logins to the document management apparatus utilizing the guest account, and can obtain, refer to, and edit the file with a high confidentiality the access right of which is owned by the user himself/herself, using the file path and the password of the encrypted PDF.

Lastly, the user management component 20 deletes the encrypted PDF which was encrypted in Step 104, from the common folder after a certain period has elapsed (S108). For this deletion processing, the file may be deleted automatically after a certain period has elapsed. The certain period may be set to be one week as a default, or an optional period may be set by the system manager when the system manager confirms a desire of the user to be deleted at each time for deleting the user account. Obviously, the system manager may carry out the deletion processing manually after a certain period has elapsed.

Thereby, it is possible to prevent the occurrence of a situation in which the encrypted file remains forever in the common area and consumes the storage capacity. Further, the encrypted file may be automatically deleted in the condition of a certain number of logins by the guest account instead of or in addition to the certain elapsed period.

### Variation of the Present Embodiment

The order of Step 100 and Step 101 may be inverted. That is, the E-mail address of the user to be deleted may be obtained in advance and then the user account may be deleted. In the case of a process in such an order, the E-mail address as the notification destination information has been already obtained when the user account is to be deleted, and thereby it is possible to extinguish the whole information regarding the user to be deleted at one time.

In Step 102, for the case that it is sufficient to be able to secure only the access to the personal folder, the search target may be limited to the personal folder of the user to be deleted. Alternatively, the contents of the access right may be limited or the search target may be only a specific file. Thereby, the whole processing including the search processing can be simplified and a burden on the system can be reduced.

In Step 104, a known encryption may be applied to the encryption format and a PDF having a policy may be used for permitting or limiting the operation of the PDF provided with the policy for each user in conjunction with a policy server, for example. Further, the file may be converted only into a compressed file with a password. Alternatively, instead of the encryption processing of the file, a common folder which can be utilized temporarily may be created and a password may be provided to the common file itself. When the common folder itself is thus encrypted, the notification information in Step 107 becomes the guest account, the password for decrypting the code of the encrypted common folder, and the file path indicating the location storing the common folder.

In Step 106, the guest account may be a temporary account which can login in a condition. Such a temporary account may be different for each user or may be a fixed common account. The temporary account can be invalidated automatically by the completion of the condition. The condition can include a certain number of logins by the guest account or the elapse of a certain number of dates.

In Step 107, the method notifying the user may not be the E-mail. For example, the notification may be carried out through a remote user interface of the document management apparatus (not shown in FIG. 1), for example. The remote user interface is a web page disclosing information of the document management apparatus on the web and can be referred to by the user via a browser. Further, the notification may be carried out through a document management application which enables the obtaining of information or document of the document management apparatus on a personal computer (including a work station).

In these cases, appropriate sets of information corresponding to the users one by one is to be stored preliminarily in the user management table 100 instead of the E-mail addresses. Then, in Step 101, the information is obtained instead of the E-mail address, and the notification to the user may be carried out using the obtained information in Step 106.

### Embodiment 2

Next, there will be described an application example of the present invention in a document management system in which the external device capable of managing a file or the like is connected to the document management apparatus via the LAN 11.

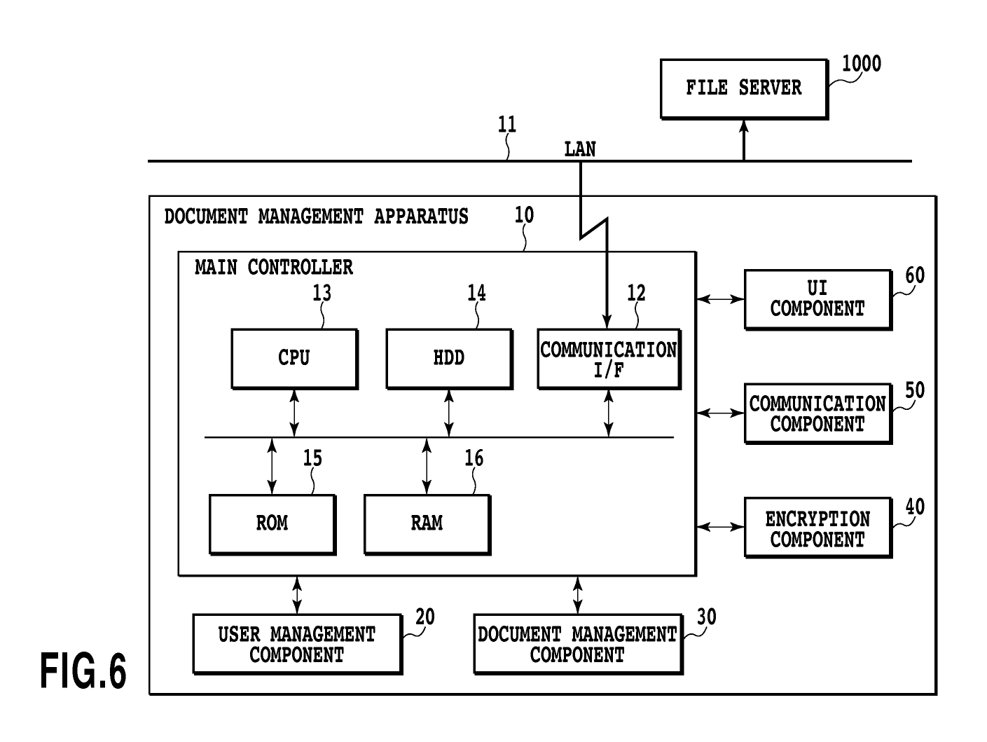

FIG. 6 is a functional block diagram of the document management system according to the present invention and shows a state in which the document management apparatus and the file server 1000 are connected to each other via the LAN 11.

The configuration of the document management apparatus is the same as that in Embodiment 1. The communication component 50 of the document management apparatus in the present embodiment can carry out file transmission by making the protocol of the communication interface 12 fit the protocol of the file server 1000. The protocol in this case includes FTP, SMB, WebDAV, etc., for example.

The file server is a sever which has a file commonly used among a plurality of users and can manage data collectively, and the file server manages the files in a tree structure as shown in FIG. 3, for example. For the file managed by the file server 1000, the document management component 30 of the document management apparatus carries out access control as in Embodiment 1. Further, the file server 1000 is provided with a communication component (not shown in the drawing) which transmits and receives the file to and from the communication component 50 of the document management apparatus by receiving a request from the document management apparatus.

The document management apparatus in the present system is controlled by the main control component 10 and performs substantially the same processing as that in the case of Embodiment 1. A point different from Embodiment 1 will be described mainly in the following.

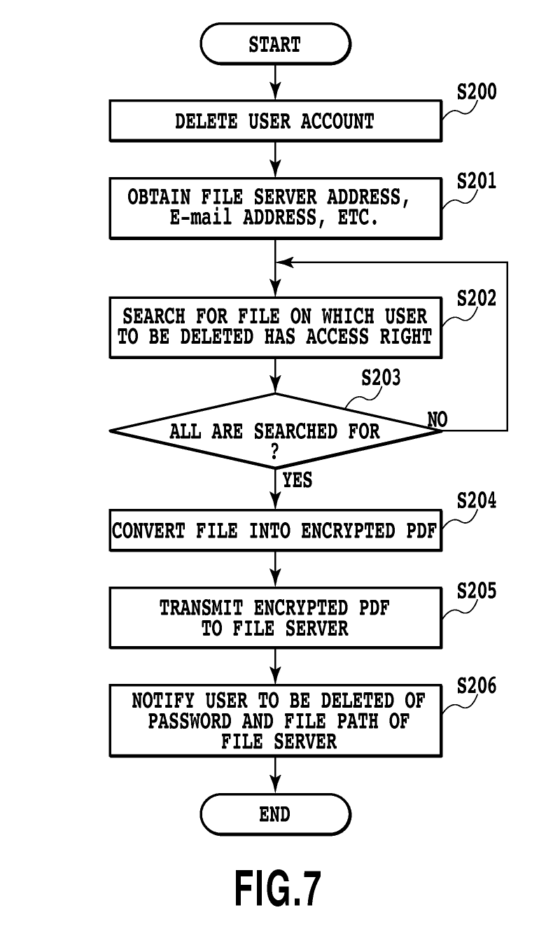

FIG. 7 is a flowchart representing control processing carried out by the document management apparatus in the present embodiment.

First, in Step 200, the system manager deletes a specific user account. After that, in Step 201, the user management component 20 refers to the user management table 100 and obtains information which is necessary in Step 206 to be described below. That is, the user management component 20 obtains information which is necessary afterward when the user to be deleted accesses a file managed by the file server 1000, such as the address of the file server 1000 in addition to an E-mail address which is notification destination information in notification to the user. The obtained information is stored temporarily in the RAM 16.

Next, in Steps 202 and 203, the document management component 30 searches for all the files, the access rights of which are owned by the user to be deleted and converts the found file into the encrypted PDF in the encryption component 40 (S204).

Then, the communication component 50 transmits the created encrypted PDF to the file server 1000 via the communication interface 12 and the LAN 11 (S205). This transmission may be carried out by an instruction of the system manager, or may be carried out automatically when the encrypted PDF has been completed. Note that the file server 1000, having received the encrypted PDF, stores the received encrypted PDF into a common area all the users can access, such as a common folder.

Next, the communication component 50 notifies the user to be deleted of information such as a password decrypting the code of the encrypted PDF and a file path on the file server 1000, by E-Mail (S206).

Note that, when the access right of the file is owned only by the user to be deleted in the result of the search, a person except the above user cannot refer to the contents of the file and thereby the file may be transmitted to the file server 1000 without the encryption processing in Step 204.

By the present system, the user whose user account has been deleted accesses the file server from any terminal (PC or the like) which can be utilized via the network, and can refer to a desired file. Accordingly, in the present embodiment, it is sufficient only to secure the access to the file server and it is not necessary to access the document management apparatus, and thereby it becomes unnecessary to carry out the management of the guest account issue and the management of the valid period thereof in Embodiment 1.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-001636, filed Jan. 7, 2009, which is hereby incorporated by reference herein in its entirety.

What is claimed is:

1. A document management apparatus, comprising:
a user management component configured to manage a user account and notification destination information of a user;
a document management component configured to manage a folder and/or a file and to perform access control according to an access right set for the folder and/or the file;
an encryption component configured to encrypt specific folder and/or file when the user management component has deleted the user account; and
a notification component configured to notify a user, the user account of whom has been deleted, of information for the user to access the encrypted folder and/or file according to the notification destination information.

2. The document management apparatus according to claim 1, wherein,
the folder managed by the document management component includes at least a common folder,
the specific folder and/or file encrypted by the encryption component are/is the folder and/or file, on which the user, the user account of whom has been deleted, has the access right,
the document management component stores the folder and/or file encrypted by the encryption component into the common folder, and
the user management component issues a guest account for the user, the user account of whom has been deleted.

3. The document management apparatus according to claim 1, wherein,
the document management component creates a common folder when the user management component has deleted the specific user account and stores the folder and/or file, on which the user, the user account of whom has been deleted, has the access right, into the common folder,
the encryption component encrypts the common folder storing the folder and/or file, and
the user management component issues a guest account for the user, the user account of whom has been deleted.

4. The document management apparatus according to claim 1, wherein
the document management component deletes the encrypted folder and/or file after a certain period has elapsed or after a certain number of logins have been carried out by the guest account.

5. The document management apparatus according to claim 1, wherein
the user management component deletes the guest account after a certain period has elapsed or after a certain number of logins have been carried out by the guest account.

6. The document management apparatus according to claim 1, wherein
the encryption of file by the encryption component includes conversion into an encrypted PDF or a PDF having a policy.

7. The document management apparatus according to claim 1, wherein
the encryption by the encryption component includes compression with a password.

8. The document management apparatus according to claim 1, wherein
the access right includes a reading right, writing right, and execution right.

9. The document management apparatus according to claim 2, wherein
the information for the user, the user account of whom has been deleted, to access the encrypted folder and/or file includes the guest account, a password that decrypts a code of the encrypted folder and/or file, and a file path of the common folder.

10. The document management apparatus according to claim 3, wherein
the information for the user, the user account of whom has been deleted, to access the encrypted common folder includes the guest account, a password that decrypts a code of the encrypted common folder, and a file path of the encrypted common folder.

11. The document management apparatus according to claim 1, wherein
the notification destination information includes an E-mail address.

12. The document management apparatus according to claim 1, wherein
the notification component notifies the user via a document management application running on a remote user interface or a personal computer.

13. A document management system in which an information device capable of managing a folder and/or file and a document management apparatus are connected to each other via a network, the document management apparatus comprising:
a user management component configured to manage a user account and notification destination information of a user;
a document management component configured to manage a folder and/or a file and to perform access control according to an access right set for the folder and/or the file;
an encryption component configured to encrypt, when the user management component has deleted the user account, the folder and/or file, on which a user, the user account of whom has been deleted, has the access right; and
a notification component configured to transmit the folder and/or file encrypted by the encryption component to the information device and to notify the user of information for the user, the user account of whom has been deleted, to access the encrypted folder and/or file according to the notification destination information.

14. The document management system according to claim 13, wherein
the information for the user, the user account of whom has been deleted, to access the encrypted folder and/or file includes a password that decrypts a code of the encrypted folder and/or file, and a file path of the information device.

15. A document management method, the method comprising the steps of:
managing, by a user management component, a user account and notification destination information of a user;
managing, by a document management component, a folder and/or a file and performing access control according to an access right set for the folder and/or the file;
encrypting specific folder and/or file when the user management component has deleted the user account by an encryption component; and
notifying, by a notification component, a user of information for the user, the user account of whom has been deleted, to access the encrypted folder and/or file according to the notification destination information.

16. A program on a computer readable storage medium having computer-executable instructions for performing a method, the method comprising the steps of:
managing, by a user management component, a user account and notification destination information of a user;
managing, by a document management component, a folder and/or a file and performing access control according to an access right set for the folder and/or the file;
encrypting specific folder and/or file when the user management component has deleted the user account by an encryption component; and
notifying, by a notification component, a user of information for the user, the user account of whom has been deleted, to access the encrypted folder and/or file according to the notification destination information.
